(19) United States
(12) Patent Application Publication
(10) Pub. No.: US 2025/0125743 A1
(43) Pub. Date: Apr. 17, 2025

(54) POWER CONVERTERS

(71) Applicant: Eaton Intelligent Power Limited, Dublin 4 (IE)

(72) Inventors: Cheng Luo, Shanghai (CN); Jianxiong Yu, Shanghai (CN); Cheng Wang, Changzhou (CN); Jiajie Duan, Shanghai (CN)

(21) Appl. No.: 18/909,127

(22) Filed: Oct. 8, 2024

(30) Foreign Application Priority Data
Oct. 13, 2023 (CN) 202311329792.2

(51) Int. Cl. H02M 7/219; H02M 7/00; H02M 7/25

(52) U.S. Cl. CPC H02M 7/219; H02M 7/003; H02M 7/25

(57) ABSTRACT

A power converter is provided. The power converter is configured to be connected between a multi-phase alternating current power supply derived from an alternating current power network and a load. For each phase of the alternating current power supply, the power converter includes n power modules, and each power module has: one alternating current input end; m power units connected in parallel to the alternating current input end; and m direct current output ends. Alternating current input ends of the n power modules are sequentially connected in series and are connected between a corresponding phase and a common node. Direct current output ends of selected power units are connected in parallel to form one direct current output of the power converter. The disclosure can simultaneously meet loads with different requirements without adding additional DC/DC converters, thereby reducing consumption generated in a power conversion process.

### CROSS-REFERENCE TO PRIORITY APPLICATION

This application claims priority to Chinese Patent Application No. 202311329792.2, filed Oct. 13, 2023, the content of which is hereby incorporated herein by reference in its entirety.

### TECHNICAL FIELD

The inventive concept generally related to electrical power supplies, and in particular, to a power converter.

### BACKGROUND

To meet power supply requirements of high-power direct current loads such as data centers and electric vehicle charging, power converters have received widespread attention. Compared with a conventional power transformer, a power converter is a power electronics solution with high power distribution efficiency and a small size, achieving power conversion from a high-voltage alternating current power network to a medium or low-voltage direct current. A front end of the power converter is connected to the alternating current power network and a rear end of the power converter is connected to a load, so that higher power density, higher efficiency, and lighter weight may be implemented in ultra-large-scale power supply applications.

A common topology of the power converter uses a cascaded H-bridge (CHB) as a rectifier circuit at an operating front end, a DC/DC isolating circuit is connected after the cascaded H-bridge to isolate a low voltage and a floating voltage, then a direct current output of the isolating circuit is connected in parallel to a common direct current bus, and a DC/DC converter needs to be connected after the common direct current bus to accommodate voltage ranges of different loads. It can be learned that this topology requires at least four power electronic stages, which leads to relatively high consumption in a power conversion process, and also causes relatively high costs.

### SUMMARY

To address the issues with conventional systems discussed above, the present inventive concept provides a power converter that can reduce a number of conversion stages from an alternating current electric to a load, thereby reducing the consumption generated in a power conversion process.

The present inventive concept provides a power converter. The power converter is configured to be connected between a multi-phase alternating current power supply derived from an alternating current power network and a load. For each phase of the alternating current power supply, the power converter includes n power modules, and each power module has: one alternating current input end; m power units, where the m power units are connected in parallel to the alternating current input end, and are configured to convert an alternating current into a direct current; and m direct current output ends. Alternating current input ends of the n power modules are sequentially connected in series and are connected between a corresponding phase and a common node; and one power unit is selected from each power module, and direct current output ends of selected power units are connected in parallel to form one direct current output of the power converter, where both n and m are integers greater than 0.

In some embodiments, the alternating current input end includes a first input terminal and a second input terminal. That alternating current input terminals of the n power modules are sequentially connected in series and are connected between a corresponding phase and a common node includes: for each phase of the alternating current power supply: the second input terminal of an i^{th} power module is connected to the first input terminal of an (i+1)^{th} power module, where i=1, 2, . . . , n−1; the first input terminal of a first power module is connected to an output end of the phase; and the second input terminal of an n^{th} power module is connected to the common node.

In some embodiments, an input end of the power unit includes a third input terminal and a fourth input terminal. That the m power units are connected in parallel to the alternating current input end includes: for each of the power units: the third input terminal of the power unit is connected to the first input terminal of a power module to which the power unit belongs; and the fourth input terminal of the power unit is connected to the second input terminal of the power module to which the power unit belongs.

In some embodiments, a direct current output end of the power unit includes a first output terminal and a second output terminal. That one power unit is selected from each power module, and direct current output ends of selected power units are connected in parallel to form one direct current output of the power converter includes: one power unit is selected from each of the power modules, first output terminals of the selected power units are connected together, and second output terminals of the selected power units are connected together, to form one direct current output of the power converter.

In some embodiments, the power unit includes a rectifier circuit and an isolating circuit that are connected in series.

In some embodiments, the rectifier circuit includes: an H-bridge, used as an active front end to perform AC/DC rectification; and the isolating circuit includes: an isolated DC/DC conversion circuit, where the isolated DC/DC conversion circuit is configured to convert a voltage and isolate a floating voltage.

In some embodiments, power units constituting a kth direct current output are connected to a controller, and the controller is configured to control the direct current output.

In some embodiments, the load is a distributed load or a centralized load.

In some embodiments, the distributed load includes a charger of an electric vehicle, a server of a data center, or a distributed battery used for energy storage.

In some embodiments, the multi-phase alternating current power supply derived from the alternating current power network is a three-phase alternating current power supply.

The power converter of the present inventive concept not only converts a high voltage of the alternating current power network into a medium or low voltage through rectification and isolation processing, to supply power to a load, but also can simultaneously meet loads with different requirements without adding an additional DC/DC converter, and reduce a number of power electronics stages from the alternating current power network to the loads, thereby reducing the consumption generated in a power conversion process, improving conversion efficiency, and reducing costs.

### BRIEF DESCRIPTION OF THE DRAWINGS

FIG. 1 is a schematic diagram of a topology of a power converter in the conventional technology.

FIG. 2 is a schematic diagram of a topology of a power converter according to some embodiments of the present inventive concept.

FIG. 3 is a schematic diagram of a connection relationship between a power module and a power unit in an R phase according to some embodiments of the present inventive concept.

FIG. 4 is a schematic diagram of an internal topology structure of a power unit according to some embodiments of the present inventive concept.

### DETAILED DESCRIPTION

The following describes in detail specific embodiments of the present inventive concept. It should be noted that the embodiments herein are merely used as examples for description, and are not intended to limit the present inventive concept. In the following description, a large number of specific details are described to provide a thorough understanding of the present inventive concept. However, it is apparent to those of ordinary skill in the art that these specific details are not necessary to implement the present inventive concept. In other examples, well-known procedures, materials, or methods are not specifically described to avoid confusion with the present inventive concept.

In the conventional technology, a power converter needs to implement conversion from a high voltage of an alternating current power network to a medium or low-voltage output. Because input power and output power are the same, a current on an input high-voltage side is relatively small, and a current on an output medium or low-voltage side is relatively large. Therefore, to withstand a high voltage from the alternating current power network, a medium-voltage power converter usually uses p cascaded H-bridges in each phase as a front-end AC/DC rectifier circuit (where p is an integer greater than 0), and a DC/DC isolating circuit is connected after the rectifier circuit. After passing through the rectifier circuit and the isolating circuit, the voltage drops, the current increases, and a direct output of the isolating circuit is connected in parallel to a common direct current bus, to complete power conversion. Although the power conversion has been completed, the common direct current bus at this time cannot be simultaneously connected to a plurality of loads with different requirements to provide services for the loads. This is because the front-end H-bridges are connected in series. Therefore, values of currents flowing through the H-bridges are the same. All currents obtained by the loads from the common direct current bus flow through the front-end H-bridges. When the loads have different requirements, the common direct current bus first meets a load with a large-current requirement. This causes that a load with a small-current requirement is unable to bear an excessive current, resulting in burned circuits and loads. For example, in a scene of a vehicle charging station, three electric vehicles that respectively require 1A, 5A, and 10A need to be connected to the foregoing common direct current bus for charging, and after the three electric vehicles are simultaneously connected to the common direct current bus, the common direct current bus charges the electric vehicle that requires 10A. In this case, the current flowing through a line is greater than the requirements of 1A and 5A, which cause burning of components and lines in the other two electric vehicles.

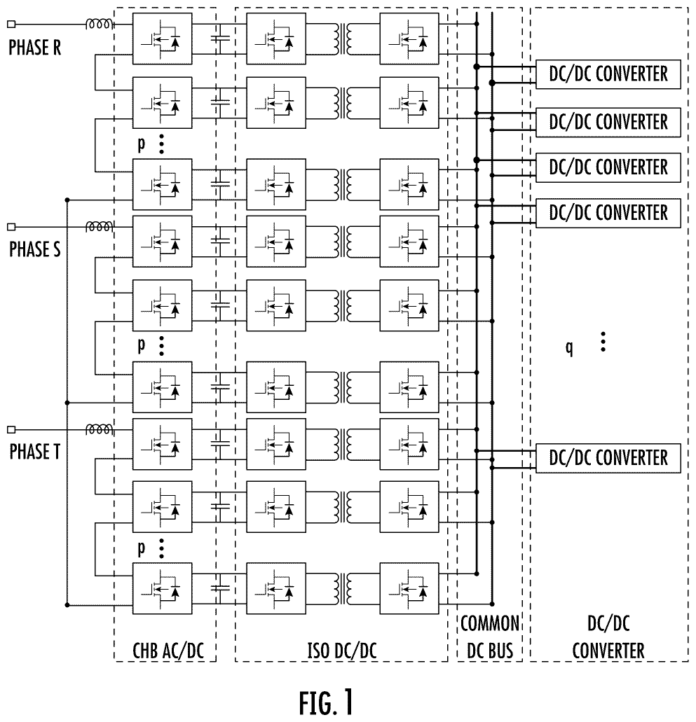

To resolve the foregoing problems, in an existing power converter, an additional DC/DC converter is added to the rear end of the common direct current bus to accommodate loads with different requirements. As shown in FIG. 1, a schematic diagram of a topology of a power converter in the conventional technology, the power converter includes a rectifier circuit (including a p-level CHB), a DC/DC isolating circuit, a common direct current bus, and q DC/DC converters, that are connected in sequence, and an output of the DC/DC converter is connected to a load, where q is an integer greater than 0.

The inventors found that such a power converter requires at least four power electronics stages from an alternating current power network to a load, resulting in relatively high consumption in a power conversion process, and also causing relatively high costs. Therefore, there is a need for further improvement of the power converter.

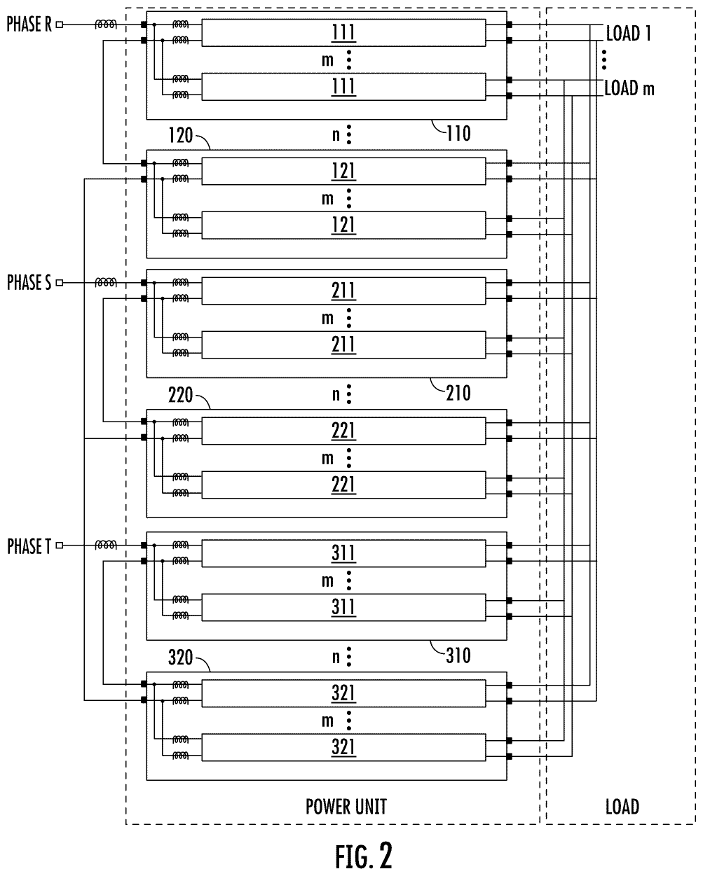

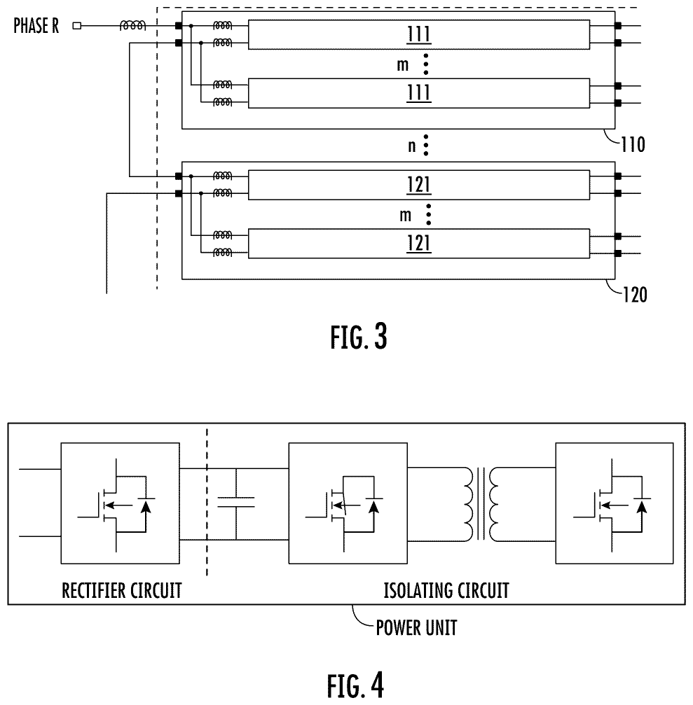

In view of the foregoing technical problems, the present inventive concept proposes a new power converter structure that can remove the additional DC/DC converter, thereby reducing system costs and improving efficiency. FIG. 2 is a schematic diagram of a power converter according to some embodiments of the present inventive concept. The power converter is configured to be connected between a multi-phase alternating current power supply (an R phase, an S phase, and a T phase in FIG. 2) derived from an alternating current power network and a load. For each phase of the alternating current power supply, the power converter includes n power modules, and each power module has: one alternating current input end, where the alternating current input end includes a first input terminal and a second input terminal; m power units, where the m power units are connected in parallel to the alternating current input end, and are configured to convert an alternating current into a direct current; and m direct current output ends. Alternating current input ends of the n power modules are sequentially connected in series and are connected between a corresponding phase and a common node, that is, for the n power modules of each phase, the alternating current input ends of first power module to last power module are connected together. Specifically, FIG. 3 shows a connection relationship between a power module and a power unit in the R phase. The n power modules from the 1^{st} power module 110 in the R phase to the n^{th} power modules 120 in the R phase are connected in series, that is, an output end of the R phase is connected to a first input terminal of the 1^{st} power module 110 in the phase, a second input terminal of the i^{th} power module is connected to a first input terminal of the (i+1)^{th} power module (i=1, 2, . . . , n−1), and a second input terminal of the (n−1)^{th} power module 120 is connected to a first input terminal of the n^{th} power module 120, sequentially. A second input terminal of the n^{th} power module 120 is connected to the common node. In some embodiments, an input end of the power unit includes a third input terminal and a fourth input terminal. That input ends of the m power units in the power module are connected in parallel to the alternating current input end includes: a third input terminal of each power unit is connected to a first input terminal of a power module to which the power unit belongs; and a fourth input terminal of each power unit is connected to a second input terminal of the power module to which the power unit belongs. For example, a third input terminal of a power unit 111 in the 1^{st} power module 110 in the R phase is connected to the first input terminal of the 1^{st} power module 110, and a fourth input terminal of the power unit 111 is connected to a second input terminal of the 1^{st} power module 110; and a third input terminal of a power unit 121 in the n^{th} power module 120 in the R phase is connected to the first input terminal of the n^{th} power module 120, and a fourth input terminal of the power unit 121 is connected to the second input terminal of the n^{th} power module 120.

As shown in FIG. 2, similarly, for the S phase, the n power modules from the 1^{st} power module 210 in the S phase to the n^{th} power module 220 in the S phase are connected in series in a connection manner of the power modules in the R phase. Correspondingly, a second input terminal of the n^{th} power module 220 is connected to the same common node, and input ends of the m power units in each power module in the S phase are connected in parallel in a connection manner of the power units in the R phase. For example, a third input terminal of a power unit 211 in the 1^{st} power module 210 in the S phase is connected to a first input terminal of the 1^{st} power module 210, and a fourth input terminal of the power unit 211 is connected to a second input terminal of the 1^{st} power module 210; and a third input terminal of a power unit 221 in the n^{th} power module 220 in the S phase is connected to a first input terminal of the n^{th} power module 220, and a fourth input terminal of the power unit 221 is connected to the second input terminal of the n^{th} power module 220.

For the T phase, the n power modules from the 1^{st} power module 310 in the T phase to the n^{th} power module 320 in the T phase are connected in series in the connection manner of the power modules in the R phase. Correspondingly, a second input terminal of the n^{th} power module 320 is connected to the same common node, and input ends of the m power units in each power module in the T phase are connected in parallel in the connection manner of the power units in the R phase. For example, a third input terminal of a power unit 311 in the 1^{st} power module 310 in the T phase is connected to a first input terminal of the 1^{st} power module, and a fourth input terminal of the power unit 311 is connected to a second input terminal of the 1^{st} power module 310; and a third input terminal of a power unit 321 in the n^{th} power module 320 in the T phase is connected to a first input terminal of the n^{th} power module 320, and a fourth input terminal of the power unit 321 is connected to the second input terminal of the n^{th} power module 320.

A direct current output end of each of the power unit includes a first output terminal and a second output terminal. Any power unit is selected from each power module, and direct current output ends of selected power units are connected in parallel to form one direct current output of the power converter. The selected power units do not need to participate in a parallel structure of another direct current output of the power converter, that is, one direct current output of each power converter includes a direct current output end of one power unit from each power module. In addition, a direct current output end of any power unit in one power module participates only in a parallel structure of one direct current output of the power converter. In some embodiments, direct current output ends of the kth power units in all power modules are connected in parallel to form the kth direct current output of the power converter. Specifically, first output terminals of the kth power units of all of the power modules are connected together, and second output terminals of the kth power units of all of the power module are connected together, to form the kth direct current output of the power converter. For each phase, first output terminals of the kth power units of all power modules in the phase are connected, and second output terminals of the kth power units are connected, to form a direct current output of the phase, where k=1, 2, . . . , m, and n, m, and k are all integers greater than 0. Then, after the direct current output ends of the power units of all the phases of the power converter are connected in parallel in a connection manner of the direct current output ends of the power units, a load may be connected and powered. The power converter in these embodiments of the present inventive concept may have a maximum of m direct current output ends. The power converter shown in FIG. 2 is used as an example. The power converter in FIG. 2 has three phases. After direct current outputs of the three phases are connected in parallel, a load may be directly connected and powered. For example, there are four stages of cascaded power modules (that is, n=4) in each of the R phase, the S phase, and the T phase, and the power module of each stage includes six power units (that is, m=6) of which input ends are connected in parallel. The R phase is used as an example. The four power modules are connected in series. Input ends of the six power units in the 1^{st} power module are connected in parallel, and internal structures and connection relationships of the 2^{nd}, 3^{rd}, and 4^{th} power modules are the same as those of the first power module. Direct current output ends of the 1^{st} power units in the 1^{st} to the 4^{th} power modules are separately pulled out, and the four direct current output ends are connected to form the 1^{st} direct current output of the R phase. Similarly, output ends of the 2^{nd} power units in the 1^{st} to the 4^{th} power modules are connected to form the 2^{nd} direct current output of the R phase, output ends of the 3^{rd} power units in the 1^{st} to the 4^{th} power modules are connected to form the 3^{rd} direct current output of the R phase, output ends of the 4^{th} power units in the 1^{st} to the 4^{th} power modules are connected to form the 4^{th} direct current output of the R phase, output ends of the 5^{th} power units in the 1^{st} to the 4^{th} power modules are connected to form the 5^{th} direct current output of the R phase, and output ends of the 6^{th} power units in the 1^{st} to the 4^{th} power modules are connected to form the 6^{th} direct current output of the R phase. That is, outputs of power units with the same sequence number in all the power modules are connected in parallel to form the direct current output of the phase. There may be a maximum of six direct current outputs in each phase after all the outputs are connected in parallel, and the direct current output is composed of the outputs of the power units with the same sequence number in the four power modules. Structures and connection manners of components in the S phase and T phase are the same as those in the R phase. Then, after the 1^{st} direct current output of the R phase, the 1^{st} direct current output of the S phase, and the 1^{st} direct current output of the T phase are connected to the 1^{st} direct current bus, a load 1 may be directly connected; and after the kth direct current output of the R phase, the kth direct current output of the S phase, and the kth direct current output of the T phase are connected to the kth direct current bus, a load k may be directly connected. In this example, the power converter can form six direct current buses, which can simultaneously meet six loads with different requirements. There may also be another manner of connecting direct current output ends of power units in parallel. For example, there are four stages of cascaded power modules (that is, n=4) in each of the R phase, the S phase, and the T phase, and the power module of each stage includes three power units (that is, m=3) of which input ends are connected in parallel. A connection manner of the input ends of the power modules and a connection manner of the input ends of the power units are the same as those described above. Details are not described herein again. One power unit is selected from each of the four power modules, and direct current output ends of selected power units are connected in parallel to form one direct current output of the power converter. For example, for each phase, direct current output ends of a power unit whose sequence number is 1 and that is selected from the 1^{st} power module, a power unit whose sequence number is 1 and that is selected from the 2^{nd} power module, a power unit whose sequence number is 2 and that is selected from the 3^{rd} power module, and a power unit whose sequence number is 3 and that is selected from the 4^{th} power module in each phase are connected in parallel, to form one direct current output of the power converter; direct current output ends of a power unit whose sequence number is 2 and that is selected from the 1^{st} power module, a power unit whose sequence number is 2 and that is selected from the 2^{nd} power module, a power unit whose sequence number is 3 and that is selected from the 3^{rd} power module, and a power unit whose sequence number is 1 and that is selected from the 4^{th} power module in each phase are connected in parallel, to form one direct current output of the power converter; and direct current output ends of a power unit whose sequence number is 3 and that is selected from the 1^{st} power module, a power unit whose sequence number is 3 and that is selected from the 2^{nd} power module, a power unit whose sequence number is 1 and that is selected from the 3^{rd} power module, and a power unit whose sequence number is 2 and that is selected from the 4^{th} power module in each phase are connected in parallel, to form one direct current output of the power converter. The power converter in the embodiments of the present inventive concept converts a high voltage of the alternating current power network into a medium or low voltage through rectification and isolation processing, to supply power to a load. The load draws average power from a power unit at a corresponding position or sequence in each power module in each phase, and a process of drawing power by the load does not affect other power units in the same power module. Therefore, the power converter can simultaneously meet loads with different requirements. In addition, the power converter in the embodiments of the present inventive concept does not need to add an additional DC/DC converter, and reduces a number of power electronics stages from the alternating current power network to the loads, so that the power converter can reduce consumption generated in a power conversion process, improve conversion efficiency, and reduce costs.

In some embodiments, the third input terminal and the fourth input terminal of the power unit each are connected in series to a filter inductor.

In some embodiments, a filter inductor is connected between an input front end of the power converter and each phase of the alternating current power network.

The power unit is configured to perform rectification and voltage transformation. In some embodiments, the power unit is further configured to isolate a floating voltage. The floating voltage may be a non-standard voltage generated by interaction between components, or may be understood as a disturbance voltage. Isolation of the floating voltage can ensure normal operation of a circuit. Internal structures of the power units in the same power converter are completely the same, and therefore structures of the power modules are also the same. In some embodiments, each power unit includes a rectifier circuit and an isolating circuit that are connected in series.

FIG. 4 is a schematic diagram of a structure of a power unit according to some embodiments of the present inventive concept. In some embodiments, a medium-voltage power unit includes an H-bridge as an active front end to perform AC/DC rectification. In some embodiments, it can also be considered to use a cascaded rectification circuit of a plurality of H-bridges as an active front end. A rectification output is connected to an isolated DC/DC conversion circuit, where the isolated DC/DC conversion circuit is configured to convert a voltage and isolate a floating voltage.

In some embodiments, power units constituting a parallel direct current output are connected to a controller, and the controller is configured to control the direct current output. Preferably, the power units constituting the parallel direct current output are connected to and share the same controller.

In some embodiments, the load may be a charger of an electric vehicle, a server of a data center, a distributed battery for energy storage, another load that requires distributed cabling, or a centralized load (when a centralized load is connected, a plurality of direct current output ends of the power converter need to be connected in parallel).

The embodiments of this specification are described in a progressive manner. Each embodiment focuses on differences from another embodiment or implementation. For identical or similar parts between the embodiments of the present inventive concept, reference can be made to each other. For implementation principles based on the inventive concept and generated technical effects, reference can be made to each other. Details are not described herein again. In a case of no conflict, the embodiments or implementations in the present inventive concept can be combined with each other.

The embodiments of the present inventive concept have been described above. The foregoing description is exemplary and not exhaustive, and is not limited to the disclosed embodiments. Many modifications and changes are apparent to those of ordinary skill in the art without departing from the scope and spirit of the described embodiments. The selection of the terms used in this specification is intended to best explain principles, practical applications, or technical improvements in the market of the embodiments, or to enable others of ordinary skill in the art to understand the embodiments disclosed herein.

### REFERENCE NUMERALS

110: 1^{st} power module in an R phase;
111: power unit in the 1^{st} power module in the R phase;
120: n^{th} power module in the R phase;
121: power unit in the n^{th} power module in the R phase;
210: 1^{st} power module in an S phase;
211: power unit in the 1^{st} power module in the S phase;
220: n^{th} power module in the S phase;
221: power unit in the n^{th} power module in the S phase;
310: 1^{st} power module in a T phase;
311: power unit in the 1^{st} power module in the T phase;
320: n^{th} power module in the T phase; and
321: power unit in the n^{th} power module in the T phase.

What is claimed is:

1. A power converter configured to be connected between a multi-phase alternating current power supply derived from an alternating current power network and a load, wherein
for each phase of the alternating current power supply, the power converter comprises n power modules, and each power module has:
one alternating current input end;
m power units, wherein the m power units are connected in parallel to the alternating current input end, and are configured to convert an alternating current into a direct current; and
m direct current output ends,
wherein alternating current input ends of the n power modules are sequentially connected in series and are connected between a corresponding phase and a common node; and
one power unit is selected from each power module, and direct current output ends of selected power units are connected in parallel to form one direct current output of the power converter,
wherein both n and m are integers greater than 0.

2. The power converter of claim 1, wherein the alternating current input end comprises a first input terminal and a second input terminal; and
that alternating current input terminals of the n power modules are sequentially connected in series and are connected between a corresponding phase and a common node comprises:
for each phase of the alternating current power supply:
the second input terminal of an i^{th} power module is connected to the first input terminal of an (i+1)^{th} power module, wherein i=1, 2, . . . , n−1;
the first input terminal of a first power module is connected to an output end of the phase; and
the second input terminal of an n^{th} power module is connected to the common node.

3. The power converter of claim 2, wherein an input end of the power unit comprises a third input terminal and a fourth input terminal; and
that the m power units are connected in parallel to the alternating current input end comprises:
for each of the power units:
the third input terminal of the power unit is connected to the first input terminal of a power module to which the power unit belongs; and
the fourth input terminal of the power unit is connected to the second input terminal of the power module to which the power unit belongs.

4. The power converter of claim 1, wherein a direct current output end of the power unit comprises a first output terminal and a second output terminal; and
that one power unit is selected from each power module, and direct current output ends of selected power units are connected in parallel to form one direct current output of the power converter comprises:
one power unit is selected from each of the power modules, first output terminals of the selected power units are connected together, and second output terminals of the selected power units are connected together, to form one direct current output of the power converter.

5. The power converter of claim 1, wherein the power unit comprises a rectifier circuit and an isolating circuit that are connected in series.

6. The power converter of claim 5, wherein the rectifier circuit comprises: an H-bridge, used as an active front end to perform AC/DC rectification; and
the isolating circuit comprises: an isolated DC/DC conversion circuit, wherein the isolated DC/DC conversion circuit is configured to convert a voltage and isolate a floating voltage.

7. The power converter of claim 1, wherein power units constituting a kth direct current output are connected to a controller, and the controller is configured to control the direct current output.

8. The power converter of claim 1, wherein the load is a distributed load or a centralized load.

9. The power converter of claim 8, wherein the distributed load comprises a charger of an electric vehicle, a server of a data center, or a distributed battery used for energy storage.

10. The power converter of claim 1, wherein the multi-phase alternating current power supply derived from the alternating current power network is a three-phase alternating current power supply.
